(19) United States
(12) Patent Application Publication
(10) Pub. No.: US 2005/0082450 A1
(43) Pub. Date: Apr. 21, 2005

(54) Lighting bracket

(76) Inventors: John Barrett, Stockport (GB); Stephen Matthews, Stockport (GB)

Correspondence Address: SHERIDAN ROSS PC, 1560 BROADWAY, SUITE 1200, DENVER, CO, 80202, US

(21) Appl. No.: 10/934,036

(22) Filed: Sep. 3, 2004

Related U.S. Application Data
(60) Provisional application No. 60/515,008, filed on Oct. 27, 2003.

(30) Foreign Application Priority Data
Sep. 5, 2003 (GB) 0320839.4
Apr. 29, 2004 (GB) 0409566.7

(51) Int. Cl. F16B 1/00

(52) U.S. Cl. 248/229.16

(57) ABSTRACT

There is disclosed a modular bracket system for attachment to shelf edges, for example on gondolas in retail premises. The bracket includes adjustable quick fit locking means that can grip a wide variety of different shelf edge profiles, and may be used with various accessory components that are slidably received in elongate sections of the bracket. The accessory components include lighting systems, jump shelves, display panels, shelf dividers, tester shelves and others. The system of the present invention is more versatile and easier to install than existing shelf edge bracket systems.

### CROSS-REFERENCE TO RELATED APPLICATIONS

This application claims priority from U.S. Provisional Patent Application No. 60/515,008 filed on Oct. 27, 2003. The entire disclosure of the provisional application is considered to be part of the disclosure of the accompanying application and is hereby incorporated by reference. This application also claims priority from United Kingdom Patent Application 0320839.4 filed on Sep. 5, 2003, and United Kingdom Patent Application 0409566.7 filed on Apr. 29, 2004.

### FIELD OF THE INVENTION

The present invention relates to a modular bracket system for connection to an edge portion of a shelf or the like.

### BACKGROUND OF THE INVENTION

Recent studies have shown that, in the retail sector, products displayed on a shelf tend to attract more customer attention when lit with artificial lighting. However, most current lighting solutions require complete replacement of existing shelving units and gondolas with custom-built units including lighting, which can be very expensive. An alternative solution is to provide small clip-on lights, but these can be unsightly and are easily dislodged in the event of accidental or deliberate contact.

One such custom-built unit is known from EP 0 441 354, which discloses a shelving system for a store incorporating a sales rack with shelves and extruded brackets for attachment to the shelves, each bracket retaining a lighting device in such a way as to hold the lighting device forward of the shelf edge so as to illuminate the front parts of products displayed below the shelf. The bracket also includes a ticket strip for holding pricing and other tickets. The bracket is affixed to the shelf edge by means of retaining screws or adhesives, which requires specialist installation skills. It is to be appreciated that EP 0 441 354 provides a total, bespoke shelving system including lighting units, and does not address the problem of providing lighting for retrofitting onto existing shelves.

Given that there is a wide variety of different shelving systems available, each having a slightly different shelf edge profile, there is a requirement for a lighting solution that may be fitted to any given shelving system.

In addition to lighting solutions, or as an alternative thereto, it is possible to create customer awareness of promotional goods by affixing information display panels (known as “shelf talkers”), leaflet holders, tester shelves, jump shelves and other such units to shelf edges. Again, however, these units generally need to be custom made for particular shelf profiles, and they are often difficult to fit.

### SUMMARY OF THE INVENTION

According to a first aspect of the present invention, there is provided an elongate bracket for connection to an edge portion of a shelf of the like, the bracket comprising a mouth section along one side thereof adapted to fix to the edge portion of the shelf or the like, the mouth section being provided with a plurality of adjustable fixing means adapted securely to grip a variety of different shelf or the like edge profiles, and the bracket having at least one elongate section along a side opposed to the mouth section and adapted slidably to receive and support a variety of accessory components each provided with a mounting section complementary to the elongate section.

The present invention also relates to a modular bracket system comprising the bracket of the first aspect in combination with one or more of the accessory components described hereinbelow.

The at least one elongate section may comprise a pair of undercut rails or the like adapted to receive mounting sections generally having a ‘T’ profile. Alternatively or in addition, the at least one elongate section may comprise a ‘C’ section or the like adapted to receive a complementary mounting rail. Alternative profiles for the elongate section and complementary mounting sections may be provided.

The mouth section may be formed generally with a ‘C’ or a ‘G’ profile, the elongate section being formed generally on the left hand side of the ‘C’ or the ‘G’ profile when viewed as presented on this page.

The adjustable fixing means are preferably mounted on the lower lip of the mouth of the ‘C’ or ‘G’ profile. A ‘G’ profile is particularly preferred, since its lower lip provides a ‘T’ section on which may be slidably mounted adjustable fixing means having a complementary ‘T’ shaped rebate. The adjustable fixing means may comprise cam locks that are rotatable about an axis generally perpendicular to a longitudinal extend of the bracket and generally parallel to a plane of the shelf or the like to which the bracket is to be affixed. Each cam lock may include a finger lever and a cam portion which are connected such that the cam portion may be rotated by the finger lever. By moving the finger lever through an appropriate rotation, the cam portion can be made to grip the shelf edge and thereby to hold the bracket in place. The cam locks may be spring loaded so as to help urge the cam portion towards an underside of the shelf edge and thereby to help secure the bracket in place.

Alternatively or in addition, the adjustable fixing means may comprise screw blocks. For example, each screw block may comprise a component having a ‘T’ shaped rebate complementary to the ‘T’ shaped section on the lower lip of the mouth section, the component further being provided with a threaded bore hole therethrough. A bolt can then be screwed into the bore hole and tightened until the bolt grips the bracket to the shelf edge. This arrangement is less preferred, since it is more time consuming to tighten a bolt than it is to operate a cam lock.

An upper lip of the mouth of the ‘C’ or ‘G’ profile is advantageously provided with an undercut along its lower edge along the length of the bracket. The undercut is adapted to receive a complementary tab or lip of a shelf divider component when the bracket is mounted on the shelf edge. The shelf divider component may comprise an elongate vertical wall with the tab or lip being formed generally perpendicular to the wall at one end and at a lower edge thereof. The undercut may additionally be adapted to receive a complementary tab or lip of a locking graphics or display panel or the like so that the panel stands upright from the shelf edge and is secured thereto by the bracket.

Various accessory components may be provided for slidable fitting into the elongate moulded section. These include extension or “jump” shelves that will stand forward of the shelf edge and which may be used for prominently displaying product testers or special promotional items. The extension shelves may be generally flat, or may be formed as troughs or the like.

Display panels (for example “shelf talkers”) and leaflet holders and the like ay also be provided, these being adapted to be slidably received by the elongate moulded section.

Ticket strip holders (for holding and displaying product pricing and other information tickets) may also be provided.

There may further be provided a lamp-retaining component adapted for slidable fitting into the elongate section. The lamp-retaining component may include a fluorescent or incandescent tube, or one or more light bulbs, or one or more LED lighting devices, or a fibre optic cable, these preferably being positioned within the lamp-retaining component so as to illuminate a shelf below that to which the bracket is fitted.

Where at least two elongate sections are provided on the bracket, these are preferably coextensive and generally parallel, such that a lamp-retaining component ay be mounted in a lower one of the at least two elongate sections and one or more other accessories may be mounted in the upper elongate section(s).

Alternatively, an accessory component such as a ticket strip holder or base nit for a ticket strip holder or the like, adapted for slidable fitting to the elongate section, may itself be provided with an elongate section adapted slidably to receive a lamp-retaining component or appropriate lighting means. The elongate section provided on the accessory component for receiving the lamp-retaining component is advantageously provided on a side of the accessory component facing the elongate racket when fitted thereto.

Instead of a lamp-retaining component being provided as a separate accessory component, it may be formed integrally with the bracket.

According to a second aspect of the present invention, there is provided a lighting bracket for connection to an edge portion of a shelf or the like, the lighting racket comprising an elongate fixing component having a section adapted to fix to the edge portion of the shelf or the like, and an elongate lamp-retaining component coextensive with the fixing component and having a section adapted to receive a lighting device, characterised in that the section of the elongate fixing component is provided with adjustable means adapted securely to grip a variety of different shelf or the like edge profiles.

The adjustable means may comprise a cam lock that is moveable between an open position and at least one locking position about a pivot point provided on the section of the elongate fixing component. The section may additionally include at least one tongue portion that is receivable in a slot of the cam lock to provide additional stability in the locking position. The cam lock may comprise a generally thin component, in which case a plurality of cam locks is provided along the length of the fixing component. Alternatively, the cam lock may comprise a generally elongate component, in which case a single cam lock may suffice to hold the fixing component to the shelf edge. The provision of a cam lock enables the fixing component to be secured to shelf edges of different thicknesses and configurations. Where the cam lock is substantially elongate, it may have a length along the longitudinal extent of the bracket in excess of 5 cm or 10 cm or more, up to the total length of the bracket. Where the cam lock is relatively thin, it may for example have a length of less than 5 cm or less than 2 cm or even less than 1 cm or 5 mm, in which case a plurality of cam locks is provided so as to ensure a secure connection of the bracket to the shelf edge along its length.

Alternatively, the adjustable means may comprise an adjustable screw fitting, with a mechanism similar to that of a G-clamp.

Alternatively, a lip and tongue mechanism may be provided, with a lip strip eing affixed to the shelf edge and a tongue strip being provided on the section of the fixing component and adapted to clip into or over the lip strip.

Alternatively, a magnetic strip may be provided on one or other or both of the shelf edge and the fixing component.

The fixing component and the lamp-retaining component are preferably formed in one piece as an integral bracket component, for example from extruded plastics or metals (e.g. aluminium), moulded plastics, folded or shaped sheet metals or any other appropriate materials. The components may alternatively be formed separately and then welded, glued, clipped or otherwise attached together.

The lamp-retaining component and/or the fixing component may have a generally re-entrant shape, i.e. having an elongate interior cavity with an elongate mouth portion having a width smaller than a maximum width of the cavity. In other words, the sections may have generally re-entrant section geometries where there is a gap or mouth allowing retention of a lighting device or shelf edge within the section, the gap or mouth serving to grip or retain or otherwise accommodate the lamp or shelf edge. The section may include straight and/or curved portions.

For example, the section may have a generally ‘C’-shaped section, where the term ‘C’-shaped is intended to include any cross-section having a shape broadly similar to the letter ‘C’, including ‘G’ and ‘U’ shapes. ‘R’, ‘H’ or ‘J’ or other section geometries may also be provided.

Alternatively, the lamp-retaining component may include or comprise a cavity that is enclosed except at one or both ends, thus allowing a strip light or the like to be slidably inserted from one end of the lamp-retaining component. In such embodiments, at least a part of the lamp-retaining component is made of a transparent or translucent material so as to allow light to pass therethrough. The lamp-retaining component may therefore comprise or include a clear tube of appropriate cross-sectional shape.

In preferred embodiments, a corner part of the section of the fixing component forms a side of the mouth of the section of the lamp-retaining component.

Because the lamp-retaining component, when installed, projects beyond the edge of the shelf, and because the mouth of the section of the lamp-retaining component is arranged to face downwardly, preferably at an angle of less than 180 degrees relative to the plane of the shelf, a lighting device mounted in the lamp-retaining component will illuminate a region under the shelf in such a way that goods displayed below the shelf will be illuminated at least partially from the front, and not just from above. This helps to ensure that the goods are displayed to best advantage. The angle may in some embodiments be less than 170 degrees, less than 160 degrees, less than 150 degrees and even less than 120 degrees or 100 degrees. When the angle is less than 90 degrees, illumination will tend to be directed above the products on display, and this is less desirable.

Advantageously, the mouth of the section of the lamp-retaining component is provided with a transparent or translucent cover, which may be clipped or slid into place or may be hinged to one side of the mouth. The cover, where provided, helps to retain a lighting device, for example a fluorescent tube or strip light, in the cavity of the section of the lamp-retaining component. The cover may additionally protect the lighting device from damage. Alternatively, one or more clips, preferably transparent or translucent, but optionally opaque, may be provided in place of the cover. The clips may help to retain the lighting device in place. Alternatively or in addition, the lighting device may be supported at each end thereof by appropriate retaining or supporting means.

A surface or elongate portion of the bracket facing generally away from the mouths of the sections is advantageously further provided with a transparent cover adapted to display pricing or other information relating to products to be displayed on the shelf. The cover may be hinged or otherwise attached to the bracket, and an inner side of the cover may be provided with retaining grooves or the like for holding one or more printed cards or tickets or the like in such a way that customer-oriented indicia (e.g. product and/or pricing information) printed on the cards or tickets are clearly visible through the cover. A part of the bracket that is covered by the cover and any printed cards or tickets held by the cover may be adapted to receive (for example between a pair of grooves) further printed cards or tickets, these cards or tickets bearing retailer-oriented indicia (e.g. stock control information, including barcodes and the like). These further cards or tickets will normally be hidden from view, but may be accessed by store employees by lifting the cover.

The surface or elongate portion of the bracket that is covered by the transparent cover may include windows (e.g. in the form of slots, holes or apertures) so as to allow light from the lighting device to pass through from the lamp-retaining component, thereby illuminating the printed cards or tickets from behind. Where the tickets are made of certain plastics or the like, they may glow brightly when illuminated from behind, thus helping to draw a customer's attention to the display. It will be appreciated that in embodiments where the lamp-retaining component is made of a transparent or translucent material, these windows may not be necessary.

The bracket may be any convenient length. It is generally preferred that the bracket is substantially the same length as the shelf edge to which it is to be mounted, although one or more shorter brackets may be mounted in a single shelf.

The bracket may be formed from extruded plastics or metals (e.g. aluminium), moulded plastics, folded or shaped sheet metals or any other appropriate materials, as may be the ticket strip holders, lamp-retaining components and other accessories.

The cross-sectional shape of the bracket may provide hidden recesses or channels for concealing electrical cabling and the like.

The bracket may also be provided with end caps for a neat appearance.

The lighting device may be an incandescent or fluorescent tube or strip light or the like, or may comprise a row of light bulbs. In some embodiments, the lighting device may be a fibre optic cable or a chain of light-emitting diodes. Other forms of lighting device may be used as required.

### BRIEF DESCRIPTION OF THE DRAWINGS

For a better understanding of the present invention and to show how it may be carried into effect, reference shall now be made by way of example to the accompanying drawings, in which:

FIGS. 1a to 1f show various arrangements of a cam lock for use with the present invention;

FIG. 2 shows the cam lock of FIG. 1 fitted to a bracket of the present invention;

FIG. 3 shows a screw block fitted to a bracket of the present invention;

FIG. 4 shows an embodiment of the bracket of the present invention from behind;

FIG. 5 shows the embodiment of FIG. 4 affixed to a shelf edge and including a ticket strip holder;

FIG. 6 is an exploded view of the extrusions used in the construction of the embodiment of FIGS. 4 and 5;

FIG. 7 shows an embodiment of the invention having an undercut on the upper lip of the mouth section adapted to hold a locking tab of a display panel;

FIG. 8 shows the display panel of FIG. 7;

FIG. 9 is a perspective view of the embodiment of FIG. 7;

FIGS. 10 to 13 show an embodiment in which a locking tab of a shelf divider is held in place by an undercut on the upper lip of the mouth section;

FIG. 14 shows a jump or extension shelf with a ‘T’ section for fitting into the elongate moulded section;

FIG. 15 shows a tester shelf with a ‘T’ section for fitting into the elongate moulded section;

FIG. 16 shows a graphic or display panel or leaflet holder with a ‘T’ section for fitting into the elongate moulded section;

FIG. 17 is an exploded view of an embodiment of the invention including lamp-retaining component and a ticket strip holder;

FIG. 18 is a perspective view of the embodiment of FIG. 17;

FIG. 19 is a cross-section through the embodiment of FIGS. 17 and 18;

FIG. 20 shows an alternative embodiment of the present invention in assembled form;

FIG. 21 shows the embodiment of FIG. 20 in exploded form; and

FIG. 22 shows an alternative view of the embodiment of FIG. 20.

### DETAILED DESCRIPTION

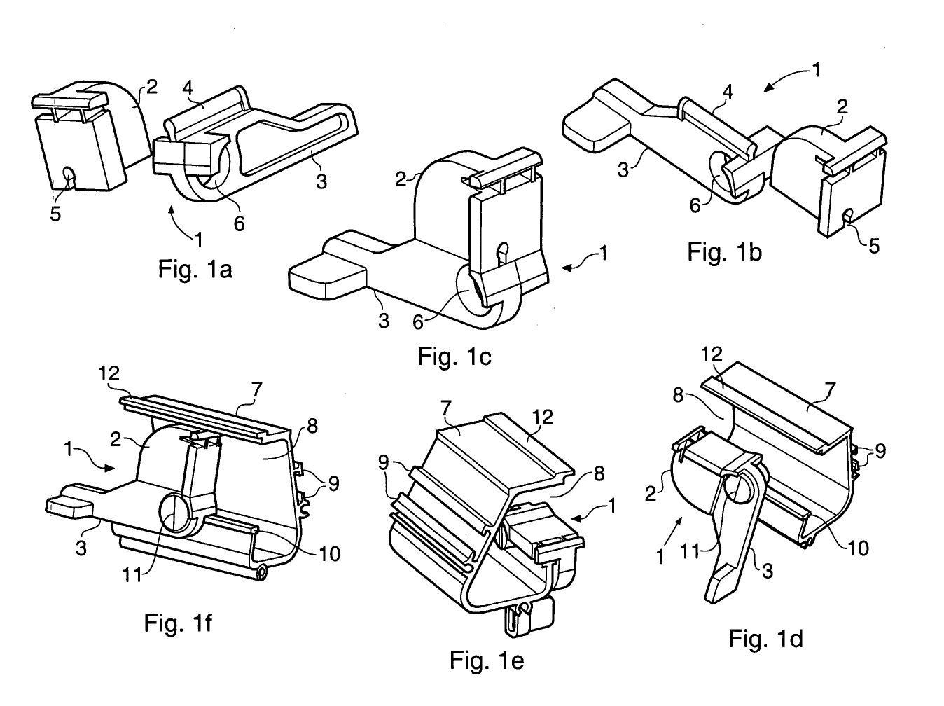

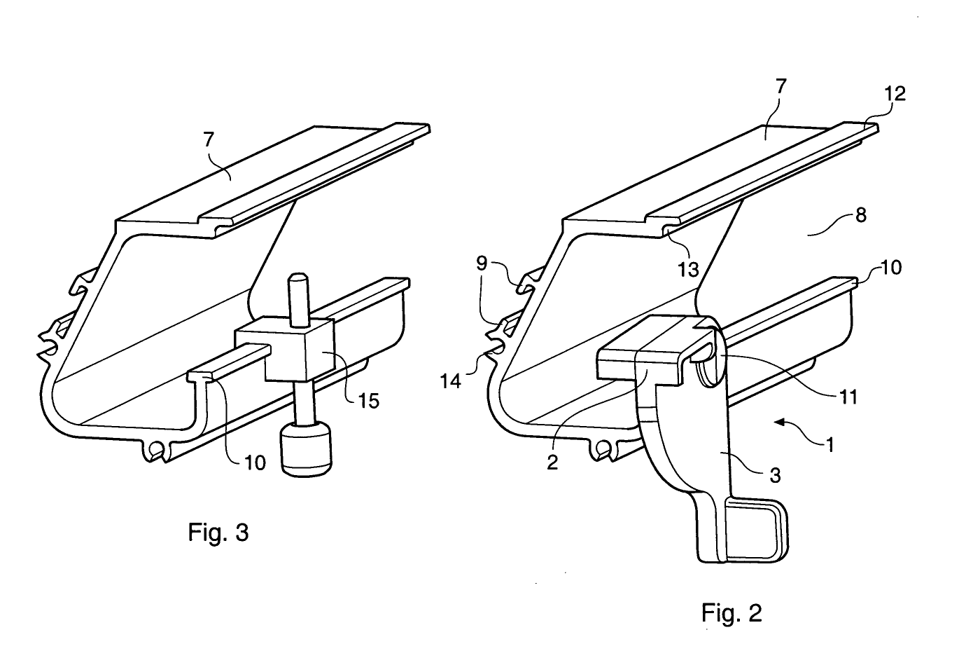

FIGS. 1a and 1b show a two part cam lock 1 comprising a cam portion 2 and a thumb lever 3 in a separated condition. The thumb lever 3 includes a cylindrical retaining bar 4 adapted to be received in a complementary recess 5 in the cam portion 2. The thumb lever 3 also includes a circular aperture 6.

FIG. 1c shows the cam lock 1 in an assembled condition.

FIGS. 1d to 1f show the cam lock 1 mounted on an elongate bracket 7 of an embodiment of the present invention. The elongate bracket 7 includes a mouth section 8 and an elongate moulded section 9 along a side opposed to the mouth section 8. The mouth section 8 has a ‘G’ profile, with a lower lip 10 having a ‘T’ section. A retaining member 11 is provided with a groove adapted slidably to receive the ‘T’ section, and the retaining member 11 in turn is received in the circular aperture 6 of the thumb lever 3. FIG. 1f shows the cam lock 1 in a closed configuration when mounted on the elongate bracket 7. In this configuration, the cam portion 2 is disposed close to an upper lip 12 of the mouth section 8 so as to allow clamping thereof to shelf edges of different thicknesses.

FIG. 2 shows the cam lock 1 mounted on the elongate bracket 7, and shows more clearly the lower lip 10, upper lip 12 (which is provided with an undercut 13) and a first elongate moulded section 9 and a second elongate moulded section 14.

FIG. 3 shows an elongate bracket 7 identical to that of FIG. 2, but instead of a cam lock 1, the lower lip 10 is provided with a screw block 15 for clamping the bracket 7 to a shelf edge.

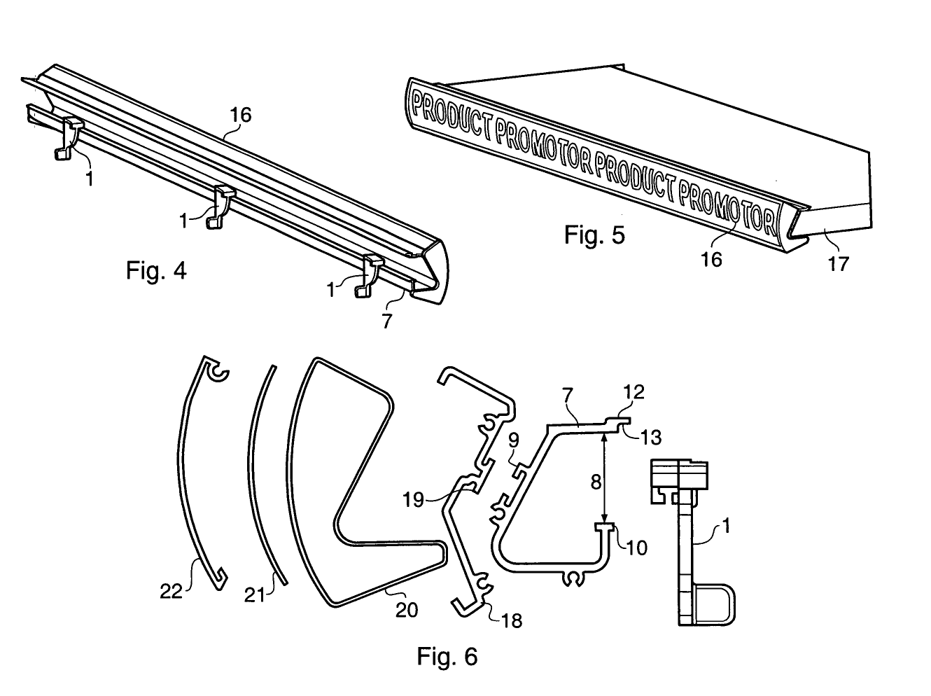

FIG. 4 shows the elongate bracket 7 and three cam locks 1, with a ticket strip holder 16 slidably received in the first elongate moulded section 9 (not shown in FIG. 4). FIG. 5 shows a different view of this arrangement when clamped to a shelf edge 17.

FIG. 6 is an exploded view of the embodiment of FIGS. 4 and 5. The elongate bracket 7 is shown with the first elongate moulded section 9. A base unit 18 of the ticket strip holder 16 has a complementary ‘T’ section elongate moulding 19 adapted to be slidably received in the first elongate moulded section 9. The ticket strip holder 16 further includes a body section 20, a ticket strip 21 and a hinged lid 22.

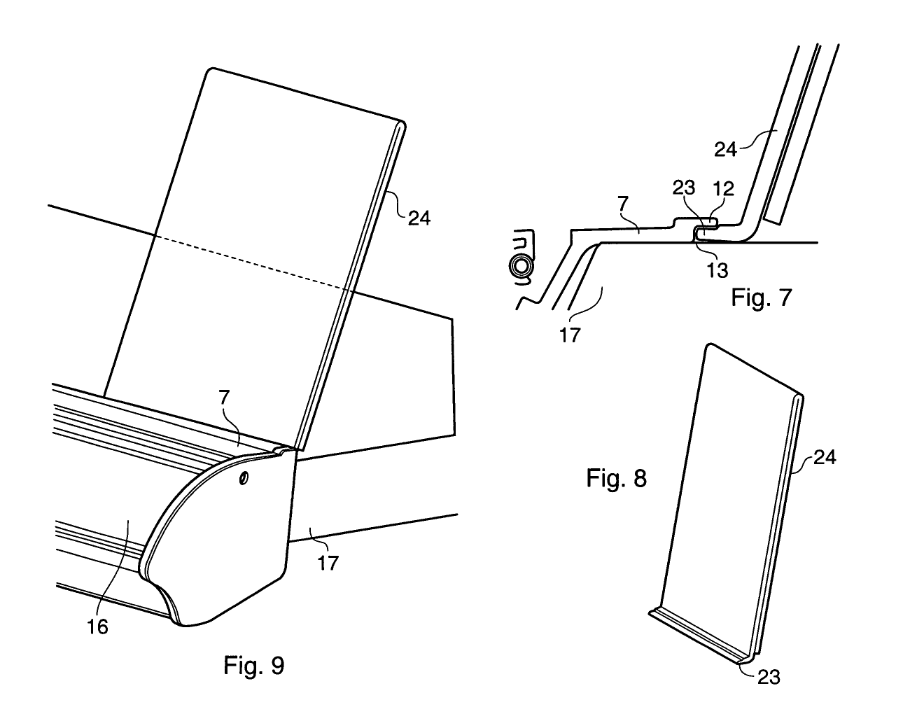

FIG. 7 shows a detail of the upper lip 12 of the mouth section 8 of the bracket 7 when clamped to a shelf edge 17. The undercut 13 receives a lip 23 of a display panel 24 and holds this securely in a raised position on a top of the shelf edge 17.

FIG. 8 shows the display panel 24, and FIG. 9 is a perspective view of the bracket 7, ticket strip holder 16 and display panel 24 securely mounted on a shelf edge 17.

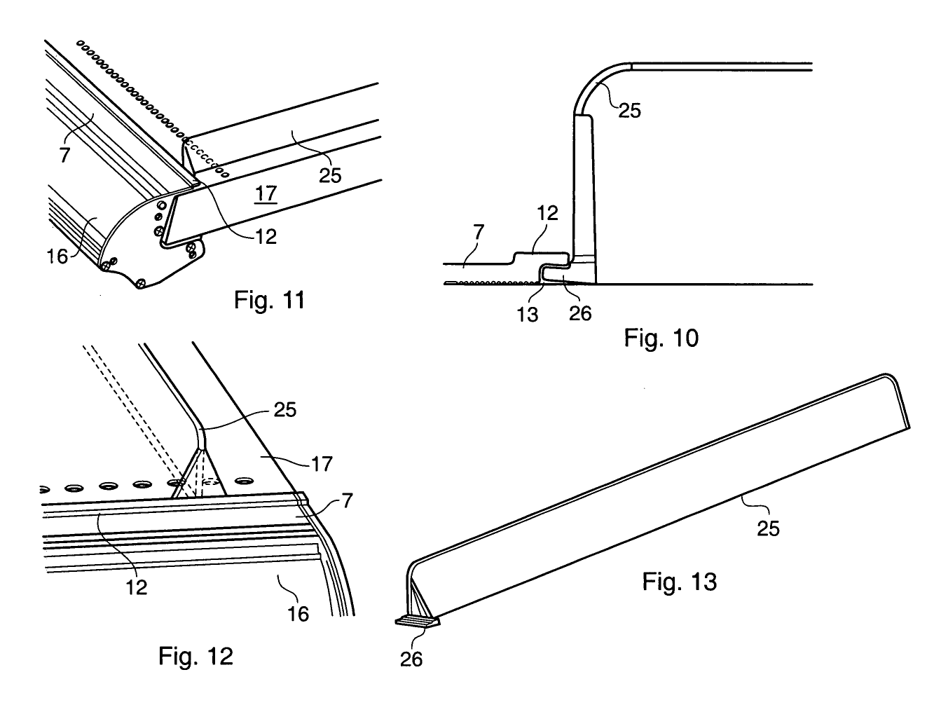

FIGS. 10 to 13 show an alternative arrangement in which a shelf divider 25 having a lip 26 is securely held by the undercut 13 so as to remain fixed in an upright position and to extend rearwardly from the shelf edge 17.

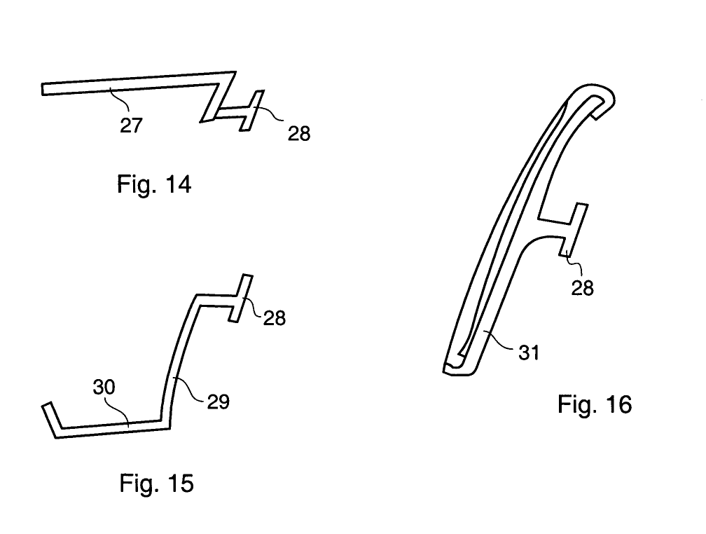

FIG. 14 shows a “jump” or extension shelf 27 provided with an elongate moulded ‘T’ section 28 adapted to be retained in the first elongate moulded section 9 of the bracket 7. The extension shelf 27 stands forward from the main shelf edge 17 and may be used for promotional displays (e.g. testers).

FIG. 15 shows tester shelf 29 similar to the extension shelf 27 of FIG. 14 and also provided with a ‘T’ section 28 adapted to be retained in the first elongate moulded section 9 of the bracket 7. The tester shelf 29 includes an elongate trough 30 for holding tester products.

FIG. 16 shows a “shelf talker” or leaflet holder 31, again with a ‘T’ section 28 adapted to be retained in the first elongate moulded section 9 of the bracket 7.

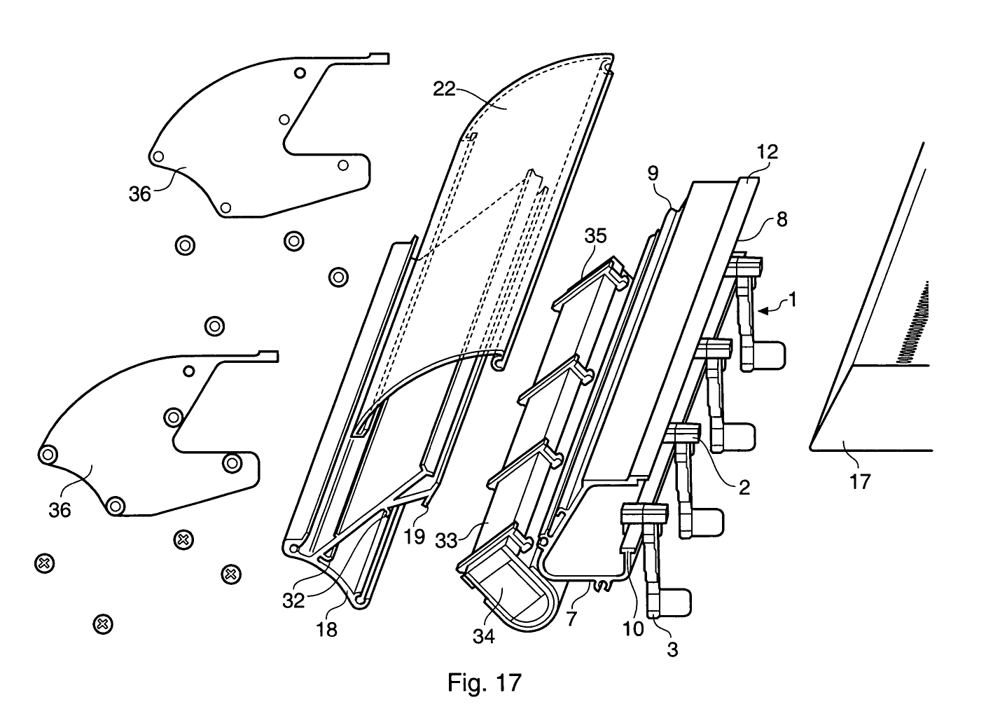

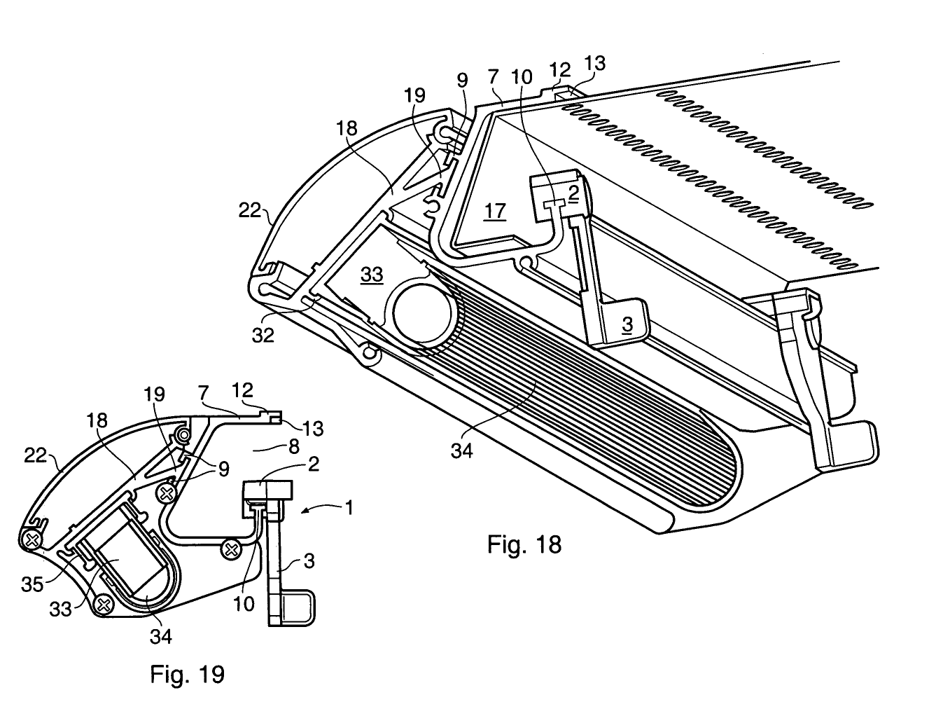

FIG. 17 shows an exploded view of an embodiment of the present invention including a light source. A bracket 7 with a mouth section 8 is provided with four cam locks 1 for attachment to a shelf edge 17. A base unit 18 of a ticket strip holder is provided with a ‘T’ section elongate moulding 19 adapted to be received in a first elongate moulded section 9 of the bracket 7. An elongate moulded section 32 adapted slidably to receive a lamp-retaining component 33 is provided on the base unit 18 on a side facing the elongate bracket 7 when fitted thereto. The lamp-retaining component 33 includes a lamp 34, and a number of retaining clips 35 that hold the lamp 34 in the lamp-retaining component 33 and also serve as means for slidably engaging the elongate moulded section 32. A hinged lid 22 and end caps 36 are also provided for the ticket strip holder and lamp-retaining component 33.

FIGS. 18 and 19 show the embodiment of FIG. 17 in an assembled condition, with like parts being labelled as for FIG. 17.

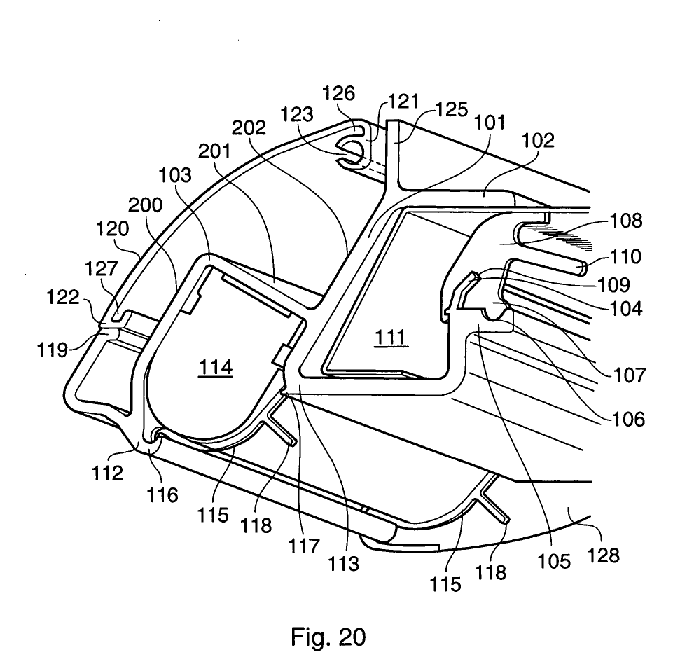

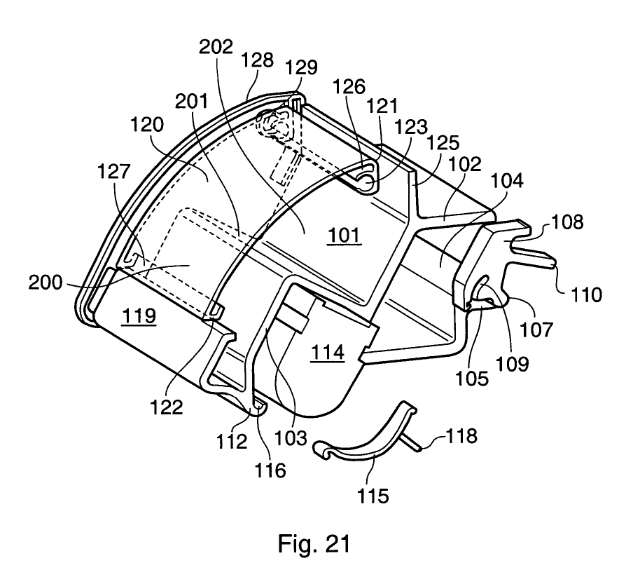

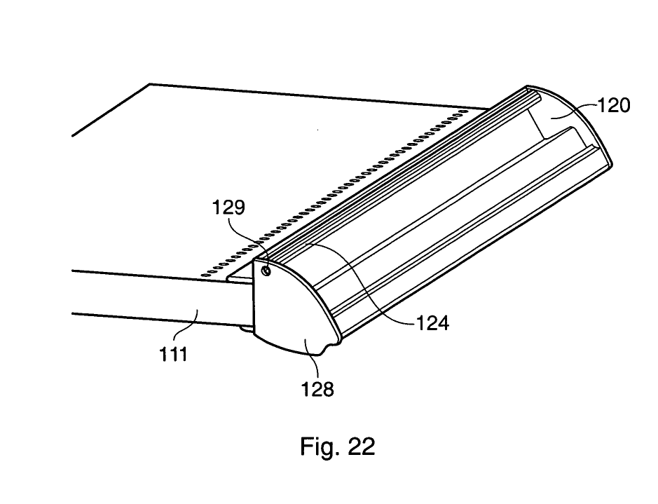

FIGS. 20 and 21 show cross-sections through a lighting bracket of an alternative embodiment of the present invention. Respectively in assembled and exploded form. FIG. 22 shows a perspective view of the assembled lighting bracket. The bracket comprises an integral aluminium extrusion 101 including a fixing component 102 with a generally ‘C’-shaped section and a lamp-retaining component 103, also with a generally ‘C’-shaped section. A mouth of the ‘C’-shaped section of the fixing component 102 is provided with a lip 104 and a flange 105 with a pivot groove 106. The pivot groove 106 is configured to support a pivot point 107 of a cam lock 108, which includes a slot 109 adapted to receive the lip 104 when the cam lock 108 is moved into a locking position by being pivoted anticlockwise about a fulcrum point defined by the pivot groove 106 and the pivot point 107. The cam lock 108 is provided with a lever 110 to assist in moving the cam lock 108 into its locking position.

The fixing component 102 is secured to a shelf edge 111 by inserting the shelf edge 111 into the mouth of the fixing component 102 and then applying the cam lock 108 as shown in FIGS. 20 and 21. It will be apparent that different thicknesses of shelf edge 111 can be gripped by using cam locks 108 with appropriate dimensions. In this way, it is possible to use a single extrusion 101 for many different shelf edges 111 simply by providing different cam locks 108, which is much cheaper and easier than having to customise the extrusion 101 for each different type of shelf edge 111.

The lamp-retaining component 103 is integral in the extrusion 101 with the fixing component 102. The lamp-retaining component 103 also has a generally ‘C’-shaped section with a mouth, the mouth of the ‘C’-shaped section of the lamp-retaining component, defined as a straight line between edge portions 112 and 113, being disposed at an angle of less than 180 degrees relative to a plane of the shelf. This angling relative to the shelf is important so as to ensure that a lamp 114 retained in the ‘C’-shaped section of the lamp-retaining component 103, which is forward of the shelf edge 111, will illuminate front faces of products displayed on a shelf located below the shelf to which the bracket 101 is attached. For maximum customer impact, it is vital that the front faces and not just the top faces of products on display are illuminated.

It can be seen that edge portion 113 of the mouth of the lamp-retaining component 103 corresponds to a corner portion of the ‘C’-shaped section of the fixing component 102. This improves illumination, since the mouth of the lamp-retaining component 103 is not obscured in any way by the fixing component 102.

The lamp 114, which may be a strip light, fluorescent tube, optical fibre device, chain of LEDs or any other appropriate lighting device, is secured in the ‘C’-shaped section of the lamp-retaining component 103 by means of clips 115 which clip into place between edge portions 112 and 113 of the mouth of the lamp-retaining component 103 (the edge portions 112 and 113 are provided with retaining lips or flanges 116, 117 for this purpose). The clips 115 may be provided with levers 118 for ease of insertion. In an alternative embodiment, the clips 115 may be replaced by a transparent or translucent cover that extends along the whole length of the lamp-retaining component.

A flange 119 provided on an external part of the ‘C’-shaped section of the lamp-retaining component 103 in a vicinity of edge portion 114 serves as a basal stop for a transparent cover 120 extending over a part of the extrusion 101 facing generally away from the shelf edge 111. The transparent cover 120, which may be made of plastics or the like, extends along the length of the bracket and has an upper edge 121 and a lower edge 122. The lower edge 122 rests on the flange 119 when the cover is in a closed position. The upper edge 121 is provided with a collar 123 which can accommodate a retaining axle 124 (see FIG. 22) allowing the cover 120 to be pivoted between a closed and an open position. The upper edge 121 abuts a flange 125 provided on an external surface of the ‘C’-shaped section of the fixing component 102.

Tickets or cards (not shown) including pricing or other information relating to goods on display on the shelf may be accommodated under the cover 120, for example between retaining grooves 126, 127 defined respectively at the upper and lower edges 121, 122. The tickets or cards can easily be replaced by opening the cover 120 when new goods are put on display or when new prices are applied to the goods. Further tickets or cards bearing retailer-oriented indicia (e.g. stock control barcodes and the like, may be provided on surfaces 200, 201 or 202 of the extrusion 101. These further tickets or cards will normally be hidden from view by the cover 120 and its cards or tickets, but may be accessed by store personnel by lifting the cover 120.

An end cap 128 is provided for each end of the bracket, as seen best in FIGS. 21 and 22. The end caps 128 are dimensioned so as to fit tightly on the ends of the extrusion 101, and are each provided with a hole 129 for accommodating the retaining axle 124 for the cover 120. Alternatively, the end caps 128 may be provided with hinge pins (not shown) that fit into the collar 123 of the cover 120, thus obviating the need for the axle 124. Any other appropriate hinge connection may be provided for pivotally connecting the cover 120 to the extrusion 101 and/or end caps 128.

The preferred features of the invention are applicable to all aspects of the invention and may be used in any possible combination.

Throughout the description and claims of this specification, the words “comprise” and “contain” and variations of the words, for example “comprising” and “comprises”, mean “including but not limited to”, and are not intended to (and do not) exclude other components, integers, moieties, additives or steps.

1. An elongate bracket for connection to an edge portion of a shelf of the like, the bracket comprising a mouth section along one side thereof adapted to fix to the edge portion of the shelf or the like, the mouth section being provided with a plurality of adjustable fixing means adapted securely to grip a variety of different shelf or the like edge profiles, and the bracket having at least one elongate section along a side opposed to the mouth section and adapted slidably to receive and support a variety of accessory components each provided with a mounting section complementary to the elongate section.

2. A bracket as claimed in claim 1, wherein the mouth section has a ‘G’ profile.

3. A bracket as claimed in claim 1, wherein the mouth section has a ‘C’ profile.

4. A bracket as claimed in claim 1, wherein the mouth section has a lower lip and wherein the adjustable fixing means are mounted on the lower lip.

5. A bracket as claimed in claim 1, wherein the adjustable fixing means comprise cam locks.

6. A bracket as claimed in claim 1, wherein the adjustable fixing means comprise screw blocks.

7. A bracket as claimed in claim 1, wherein the mouth section has an upper lip and wherein the upper lip is provided with an undercut.

8. A bracket as claimed in claim 1, further including a ticket strip holder as the accessory component.

9. A bracket as claimed in claim 1, further including a shelf as the accessory component.

10. A bracket as claimed in claim 1, further including a lamp-retaining component as the accessory component.

11. A bracket as claimed in claim 1, further including an elongate accessory component including an elongate section adapted to receive a mounting section of a secondary accessory component, the elongate section of the accessory component being disposed on a side of the accessory component facing towards the bracket.

12. A bracket as claimed in claim 11, further including a lamp-retaining component as the secondary accessory component.

13. A bracket as claimed in claim 12, wherein the accessory component is a ticket strip holder.

14. A bracket as claimed in claim 1, wherein there is provided at least one additional elongate section along the side opposed to the mouth section, substantially parallel to the elongate section, the additional elongate section also being adapted slidably to receive accessory components.

15. A bracket as claimed in claim 7, in combination with a further component having a tab or lip that is received and gripped by the undercut of the upper lip when the bracket is mounted on a shelf edge.

16. A bracket as claimed in claim 15, wherein the further component is a shelf divider.

17. A bracket as claimed in claim 15, wherein the further component is a display panel.

18. A lighting bracket for connection to an edge portion of a shelf or the like, the lighting bracket comprising an elongate fixing component having a section adapted to fix to the edge portion of the shelf or the like, and an elongate lamp-retaining component coextensive with the fixing component and having a section adapted to receive a lighting device, characterised in that the section of the elongate fixing component is provided with adjustable means adapted securely to grip a variety of different shelf or the like edge profiles.

19. A bracket as claimed in claim 18, wherein the fixing component and the lamp-retaining component are formed as an integral extruded component.

20. A bracket as claimed in claim 18, wherein the fixing component has a re-entrant section with a cavity and a mouth.

21. A bracket as claimed in claim 18, wherein the lamp-retaining component has a re-entrant section with a cavity and a mouth.

22. A bracket as claimed in claim 18, wherein the lamp-retaining component includes or comprises an enclosed tubular section at least part of which is transparent or translucent.

23. A bracket as claimed in claim 21, wherein a corner part of the section of the fixing component forms a side of the mouth of the section of the lamp-retaining component.

24. A bracket as claimed in claim 21, further comprising at least one clip adapted for releasable connection across the mouth of the section of the lamp-retaining component.

25. A bracket as claimed in claim 21, further comprising at least one transparent or translucent cover adapted for releasable connection across the mouth of the section of the lamp-retaining component.

26. A bracket as claimed in claim 18, wherein the adjustable means comprises at least one cam lock for securing the fixing component to the edge portion of the shelf or the like.

27. A bracket as claimed in claim 18, wherein the adjustable means comprises at least one screw clamp for securing the fixing component to the edge portion of the shelf or the like.

28. A bracket as claimed in claim 18, wherein an elongate surface of the bracket including at least part of an exterior surface of the section of the lamp-retaining component is provided with a transparent cover adapted to retain tickets or cards bearing pricing or other indicia.

29. A bracket as claimed in claim 18, wherein an elongate surface of the bracket including at least part of an exterior surface of the section of the lamp-retaining component is provided with means for retaining tickets or cards bearing stock control or other indicia.

30. A bracket as claimed in claim 28, wherein the elongate surface is provided with windows to allow light to pass therethrough from the section of the lamp-retaining component.

31. A bracket as claimed in claim 28, wherein the cover is provided with inner retaining grooves for retaining the tickets or cards.

32. A bracket as claimed in claim 28, wherein the cover is pivotally attached to the bracket.
